(19) United States
(12) Patent Application Publication
(10) Pub. No.: US 2006/0091575 A1
(43) Pub. Date: May 4, 2006

(54) METHOD AND SYSTEM FOR MAKING INTERIOR VEHICLE TRIM PANEL HAVING SPRAYED SKIN

(75) Inventors: Jerome J. Sroka, St. Clair Shores, MI (US); Randy S. Reed, Fair Haven, MI (US); John G. Smith, West Liberty, IA (US); Glenn A. Cowelchuk, Chesterfield, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/904,305

(22) Filed: Nov. 3, 2004

(51) Int. Cl. B29C 44/06

(52) U.S. Cl. 264/46.5; 264/309; 425/4 R; 425/103

(57) ABSTRACT

In at least certain embodiments, the present invention provides a method and system for making a vehicle interior trim panel. The method comprises providing a spray mold, heating the spray mold to a first temperature, spraying powdered polymeric material proximate the surface of the tool to form a polymeric skin layer, and cooling the spray mold to a second temperature. The method further comprises removing the skin layer from the tool and positioning the skin layer in a mold in a spaced apart relationship from a substrate, and introducing a foam material between the substrate and the skin layer to form a foam layer between the substrate and the skin layer.

### BACKGROUND OF THE INVENTION

1. Field of the Invention

The invention relates to spray formed skins for interior vehicle trim panels and method and systems for making the same.

2. Background Art

Prior vehicle parts and manufacturing methods are disclosed in U.S. Pat. Nos. 5,662,996, 6,210,614, and 6,544,449 and U.S. Patent Application Nos. 2002/0185784, 2004/0113322, 2004/0065981 and 2004/0134588, for example.

### SUMMARY OF THE INVENTION

Under the invention, a method for making a vehicle interior trim panel is provided. In at least one embodiment, the method comprises providing a spray mold, heating the spray mold to a first temperature, and spraying powdered polymeric material proximate the surface of the tool to form a polymeric skin layer. The method further comprises cooling the spray mold to a second temperature, removing the skin layer from the tool and positioning the skin layer in a mold in a spaced apart relationship from a substrate, and introducing a foam material between the substrate and the skin layer to form a foam layer between the substrate and the skin layer.

Under the invention, a system for making a vehicle instrument panel is also provided. The method comprises a spray mold capable of being selectively heated to a first temperature and cooled to a second temperature, a spray device for spraying powdered polymeric material proximate the surface of the tool to form a polymeric skin layer, and a foam tool for introducing a foam material between the substrate and the skin layer to form a foam layer between the substrate and the skin layer.

In at least one embodiment, the first temperature is greater than the second temperature. In at least another embodiment, the first temperature is greater than the melting point of the polymeric material. In at least another embodiment, the first temperature is at least 235° C.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is perspective view of an instrument panel according to the invention for use in motor vehicle;

FIG. 2 is a cross sectional view of the panel taken along the line 2-2 of FIG. 1;

FIG. 3 is a schematic view of a spray mold and a spray assembly for use in forming the panel, wherein the spray assembly is shown applying material on the tool to form a skin layer; and

FIG. 4 is a schematic view of the skin layer spaced from a substrate between first and second mold portions of a mold and showing application of a foam material between the skin layer and the substrate.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims indicating amounts of materials or conditions of reactions and/or use are to be understood as modified by the word “about” in describing the broader scope of this invention. Practice within the numerical limits stated is generally preferred. Also, unless expressly stated to the contrary, percent “parts of,” and ratio values are by weight and the description of a group or class of materials as suitable preferred for a given purpose in connection with the invention implies that mixtures of any two or more members of the group or class may be equally suitable or preferred.

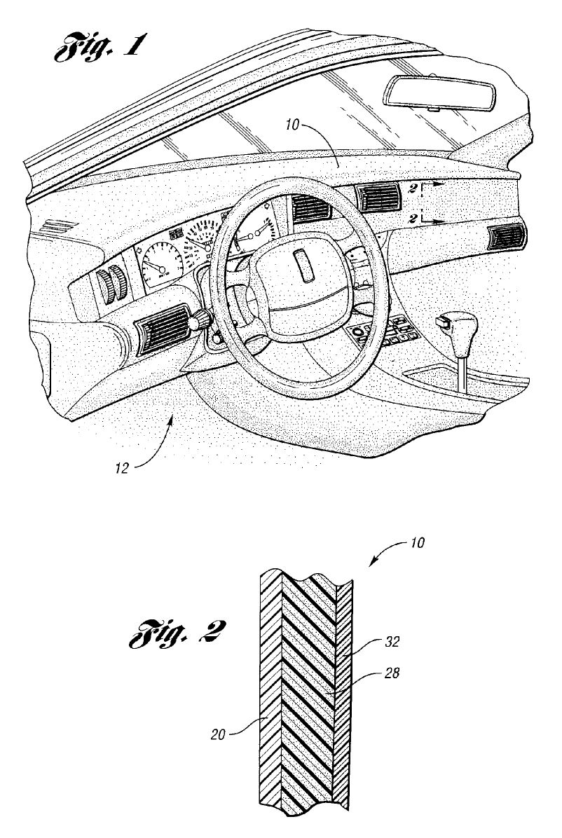

FIGS. 1 and 2 show an interior vehicle trim component, such as an instrument panel 10, according to the invention for use with a motor vehicle 12. In at least one embodiment, the instrument panel 10 includes a rigid substrate 20, a foam layer 28 secured to the substrate 20, and a skin layer 32 secured to the foam layer 28.

The substrate 20 is a structural member that provides support for the remainder of the panel 10, and may comprise any suitable material. For example, the substrate 20 may be made of plastic or reinforced plastic such as fiberglass reinforced polyurethane. Additional examples of suitable plastics, besides polyurethane, include polypropylene, polyethylene, acrylonitrile butadiene styrene (ABS), polycarbonate (PC), and ABS/PC blends. In at least one embodiment, the substrate may have a general thickness of between 0.5 to 5 mm, in another embodiment 1.0 to 3.5 mm, and in yet another embodiment 2.0 to 3.0 mm.

The foam layer 28 is adhered between the substrate 20 and the skin layer 32. The foam layer 28 generally contours to the substrate 20. The foam layer 28 helps to provide a soft feel to the instrument panel 10. The foam layer 28 may comprise any suitable foam material. For example, the foam layer 28 may comprise a foam in place polyurethane foam. In at least one embodiment, the density of the foam layer 28 is in the range of 0.05 to 0.20 grams per cubic centimeter (g/cm³). In at least one embodiment the foam layer 28 has a thickness, of 3.0 to 25 mm, and in at least another embodiment 5 to 15 mm, and in yet another embodiment 8 to 12 mm. The foam layer 28 may have varying thicknesses depending upon the configuration of the panel 10.

The skin layer 32 is adhered to the foam layer 28. Moreover, the skin layer 32 is configured to provide a covering over, and is generally contoured to, the foam layer 28. The skin layer 32 is formed by spraying a powder polymeric material. The polymeric material may be PVC, TPU, TPO, TPE, or any combination thereof. The skin layer 32 may have any suitable thickness and density. For example, the skin layer 32 may have a thickness in the range of 0.4 to 2 mm and a density in the range of 0.85 to 1.2 g/cm³. In at least one embodiment, the skin layer 32 has a thickness in the range of 0.5 to 1.2 mm, and a density in the range of 0.95 to 1.1 g/cm³. The skin layer 32 may be configured to provide a sufficiently durable and attractive surface such that an exterior coating is not needed.

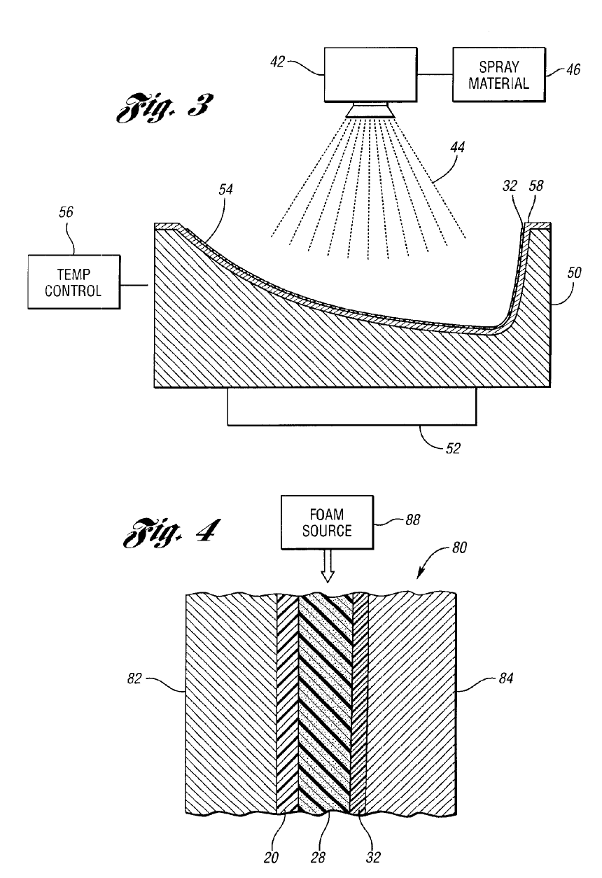

Referring to FIGS. 3-4, a method of manufacturing the instrument panel 10 will now be described. The method may begin by spraying an optional mold release agent and then skin layer forming material 44 on a spraying mold tool 50 using any suitable spray device, such as robotic high volume low pressure (such as 1 to 40 psi) spray assembly 42 having one or more moveable spray nozzles. In at least one embodiment, the spray assembly 42 is operated at ambient temperature. In at least one embodiment, the spray assembly 42 comprises a HVLP (high volume low pressure) gun available from Devilbiss of Glendale Heights, Ill. A source 46 of skin layer forming material 44 is in fluid communication with the spray assembly 42. The tool 50 is supported on base 52 and has a spray receiving surface 54 generally corresponding to the surface of the panel 10.

The tool 50 is in communication with temperature controls, shown schematically as 56, to enable the tool 50 to be selectively heated and cooled to any suitable desired temperature. Any suitable temperature control system can be used to heat the mold surface. Suitable examples of temperature controls 56 include providing heating/cooling lines in the tool 50, exposing the tool 50 to hot steam and cool mists, IR, hot oil, hot air, and hot water, and liquid coolant, cold air, liquid nitrogen and ethylene glycol mixture.

The tool 50 can be made of any suitable material, and in at least one embodiment, is predominantly made of nickel. In at least an embodiment, the tool 50 has a conductive exterior surface layer 58 to help the responsiveness of the tool 50 to temperature control. A suitable example of a material that the conducive layer 58 can be made of includes, but is not necessarily limited to, copper.

The spraying of the skin layer forming material 44 onto the tool 50 forms skin layer 32. The skin layer 32 forms when the skin layer forming material 44 is fused to form a substantially uniform layer. The skin layer forming material 44 may be any suitable sprayable polymeric powder substance and, as described above, may be applied using any suitable spray device 42. In at least one embodiment, the skin layer forming material 44 comprises cryogenically ground polymeric powder. In at least one embodiment, the powder may have an average particle size of less than 500 microns, in yet another embodiment of less than 350 microns, in yet other embodiments of 100 to 300 microns, and in yet other embodiments of 150 to 250 microns. In at least one embodiment, the polymeric material comprises thermoplastic materials such as PVC, TPU, TPO, TPE, and mixtures thereof. In at least one particular embodiment, the polymeric powder comprises PVC powder having an average particle size of less than 250 microns, available under the name of SVBX3574, from PolyOne Co. of New Baltimore, Ohio.

Prior to and during at least a substantial portion of the spraying the skin layer forming material 44 onto the mold 50, the surface mold 50 is heated to at least the melting point of the forming material 44. In at least one embodiment, the mold 50 is heated to a temperature of at least 235° C., in another embodiments 250 to 400° C., and in yet another embodiment 260 to 315° C.

As discussed above, the mold 50 is heated by temperature control 56, such as by exposing the mold 50 to heat via exposure to steam, IR, hot air, or hot oil, to name a few. In some cases the exposure can be directly, or indirectly (such as via temperature control tubes/channels, (not shown)), to the mold 50. After sufficient skin layer forming material 44 has been deposited on mold 50 to form the skin layer 32, the mold 50 is cooled to allow the material 44 to solidify and fuse together to form skin layer 32 and to allow skin layer 32 to be removed for further processing. To remove the skin layer 32, the skin layer must be cooled, in at least one embodiment to 50° C., in another embodiment 20 to 45° C. and in yet another embodiment 25 to 43° C. As discussed above, the mold 50 is cooled by temperature control 56, such as by exposing the mold 50 to cold via exposure to liquid coolant, cold air, liquid nitrogen, ethylene glycol mixture. In some cases this exposure can be directly, or indirectly, to the mold 50.

Next, referring to FIG. 4, the method involves removing the skin layer 32 from the mold tool 50 and positioning the skin layer 32 in a foam in place mold 80 having a first mold portion 82 and a second mold portion 84. At least one of the mold portions 82 and 84 are movable relative to the other. In particular, the skin layer 32 in at least one embodiment, is provided on the second mold portion 84.

A substrate 20 may be suitably provided on the first mold portion 82 in a spaced apart relation from the composite skin 86. The mold portions 82 and 84 may then be closed together, and foam material can be injected at a relatively low pressure (such as 15 to 30 psi), from foam source 88, into the mold 80 through one or more injection passages (not shown) to form the foam layer 28, which bonds to the substrate 20 and the resilient layer 30. The instrument panel 10 may then be removed from the mold 80.

In at least one embodiment, the exterior surface (i.e., the “A” surface) of the skin 32 can be post-painted, i.e., after removal from mold 50, with a suitable gloss control coating, such as a1-K waterborne interior grade paint from Red Spot company of Evansville, Ind., to provide a panel 10 having a gloss level of 1.5 to 5 measured at 60 degrees, and in other embodiments of 2 to 3 measured at 60 degrees.

Examples of other vehicle parts that may be manufactured by the above method includes door panels, package shelves, pillar trim panels, trim products, door covers, console covers, shelves, and trim covers, among others.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for making a vehicle interior trim panel, said method comprising:
providing a spray mold;
heating the spray mold to a first temperature;
spraying powdered polymeric material proximate the surface of the tool to form a polymeric skin layer;
cooling the spray mold to a second temperature;
removing the skin layer from the tool and positioning the skin layer in a foam mold in a spaced apart relationship from a substrate; and
introducing a foam material between the substrate and the skin layer to form a foam layer between the substrate and the skin layer.

2. The method of claim 1 wherein the first temperature is greater than the second temperature.

3. The method of claim 2 wherein the first temperature is greater than the melting point of the polymeric material.

4. The method of claim 3 wherein the first temperature is at least 235° C.

5. The method of claim 1 wherein the powdered polymeric material has an average particle size of less than 500 microns.

6. The method of the claim 5 wherein the polymeric material is selected from the group consisting of PVC, TPU, TPO, TPE, and mixtures thereof.

7. The method of claim 6 wherein the polymeric material is PVC.

8. The method of claim 1 wherein the skin layer has a thickness of 0.4-2.0 mm.

9. The method of claim 1 wherein the step of heating the mold comprises exposing the mold steam.

10. A vehicle interior trim component for use with a motor vehicle, the trim component comprising the panel made by the method of claim 1.

11. A system for making a vehicle interior trim panel, said method comprising:
a spray mold capable of being selectively heated to a first temperature and cooled to a second temperature;
a spray device for spraying powdered polymeric material proximate the surface of the tool to form a polymeric skin layer; and
a foam tool for introducing a foam material between a substrate and the skin layer to form a foam layer between the substrate and the skin layer.

12. The system of claim 11 wherein the first temperature is greater than the second temperature.

13. The system of claim 12 wherein the first temperature is greater than the melting point of the polymeric material.

14. The system of claim 13 wherein the first temperature is at least 235° C.

15. The system of claim 11 wherein the powdered polymeric material has an average particle size of less than 350 microns.

16. The system of the claim 15 wherein the polymeric material is selected from the group consisting of PVC, TPU, TPO, TPE, and mixtures thereof.

17. The system of claim 16 wherein the polymeric material is PVC.

18. The system of claim 11 wherein the skin layer has a thickness of 0.4-2.0 mm.

19. The system of claim 11 wherein the step of heating the mold comprises exposing the mold steam.

20. The system of claim 11 wherein the gun is capable of spraying at pressures of 1-10 psi.
